(19) United States
(12) Patent Application Publication
(10) Pub. No.: US 2009/0328138 A1
(43) Pub. Date: Dec. 31, 2009

(54) SYSTEM FOR CONTROLLING ACCESS TO HOSPITAL INFORMATION AND METHOD FOR CONTROLLING THE SAME

(76) Inventors: Sung-Young Lee, Seongnam-si (KR); Young-Koo Lee, Suwon-si (KR); Hee-Jo Lee, Namyangu-si (KR); Xuan Hung Le, Yongin-si (KR)

Correspondence Address: SHERR & VAUGHN, PLLC, 620 HERNDON PARKWAY, SUITE 320, HERNDON, VA, 20170, US

(21) Appl. No.: 12/494,410

(22) Filed: Jun. 30, 2009

(30) Foreign Application Priority Data
Jun. 30, 2008 (KR) 10-2008-0062962

(51) Int. Cl. H04L 9/32; G06F 21/00

(52) U.S. Cl. 726/1; 726/7

(57) ABSTRACT

A method and system for implementing activity-oriented access control (AOAC) to hospital information is disclosed. An access request device sends user credentials attaching user attributes to an AOAC server, which in turn searches activity rules that are assigned to user attributes from an activity server and a current work situation of the user from an activity recognition server. The AOAC server transmits an access request list corresponding to the activity rules and the current work situation of the user to the access request device so that it can select a desired access request among the list.

### BACKGROUND OF THE INVENTION

1. Field of the Invention

This invention relates generally to computer security, and more specifically, to controlling access of clinical workers to hospital information.

2. Description of the Related Art

Hospital information including medical as well as non-medical information (e.g. medical history, diagnostic images, diagnostic test result, billing, etc) is stored in digital form on hospital database. Hospital staffs including doctors, nurses, etc. frequently make an access to such information for the purpose of healthcare and administrative work. As examples, doctors need to access to their patient's medical history to give a proper treatment, nurses observe patient status and need to write progress note into database, etc.

Based on our observation, hospital work is characterized by the need to manage multiple activities simultaneously, constant local mobility, frequent interruptions, and intense collaboration and communication. These conditions impose important demand on users that need to switch frequently between tasks, contributing to a decrease in efficiency and becoming a source of errors and mishaps. Users must constantly log in to and out of devices, activating and deactivating sets of applications, looking for information needed for their care and requesting to access that information repeatedly.

Existing access control models exploit user identity/role information to determine the set of access permissions [US2007/0078677A1, US2005/0021376A1, US2003/0308381A1, Lampson 1969, Ferraiolo et al 2001, A. Corradi et al 2004]. The policy specification of these models tightly couple identity/role of users with their permissions. This coupling requires security administrators to envisage all types of missions that a user may carry out in the organization so that they can grant proper access privileges. It practically burdens administrator's jobs. Applying those approaches therefore are not appropriate. Some works adopt context only to limit the applicability of the available permissions. Meanwhile, other works use context as the foundation to authorize access. However, their concept of context is so general, for example location context, time context, system context, etc. It does not specify actual mission of users. Consequently, such approaches fail to work in activity-centered environments like hospital. The design of appropriate access control model to increase efficiency of professional hospital staff's work is essential.

### SUMMARY OF THE INVENTION

According to the present invention, a user within AOAC system is allowed to perform a certain activity if his attributes, maintained in digital credentials, are satisfactory to system policies. Each activity is provided a collection of permission on privileges, that is, the right to access to a set of objects. The advantages provided by AOAC are facilitating user's work, and reducing complexity and cost of access management in hospital information systems. Users don't need much concern on searching information related to their tasks, log in and out, and sending access request repeatedly. All relevant information is automatically provided according to the actions. The administrator does not have to perceive which user/role is granted what access privileges to which resource. Instead, he only needs to assign users to a certain activities, which is more natural and easier. Access rights are provided automatically according to user's activities, so that users can accomplish their jobs. See details of AOAC in Le Xuan Hung et al (2007).

To implement AOAC in real hospital environments, an Activity Recognition Module (ARM) is integrated to provide user activity input for AOAC engine. The ARM is in charge of detecting user's activity in a real-time manner by using an intelligent system engine to deduce activity based on real-time sensing information.

To begin with, a user logs in to his handheld device (e.g. PDA) by any mean of authentication such as username/password, smartcard, biometric authentication, etc. If successful, then the PDA establishes a session and sends a list of user credentials attaching his attributes to the authentication server. The authentication server authenticates credentials and maintains this session. Whenever the ARM detects a new activity from the user, it sends to AOAC engine including <userID> and <actionID>. AOAC looks up in LDAP server, in which maintains user activities and system policies, for matching the user activity. If it matches, then corresponding access permissions are sent to user PDA. Upon which access permission is requested from user, the system accepts and sends corresponding response to the user PDA.

AOAC policies are written in eXtensive Markup Language (XML) format conforming to extensive Access Control Markup Language (XACML) standard. User activities and policies are stored in a Lightweight Directory Access Protocol (LDAP) server. The AOAC engine communicates with LDAP server for retrieving policies via Secure Socket Layer (SSL) connection.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram which shows the system for controlling access to hospital information according to an embodiment of the present invention.

FIG. 2 illustrates the AOAC engine server and relationship in the system for controlling access to hospital information according to an embodiment of the present invention.

FIG. 3 illustrates the relation between users and activity and activity and permissions of the system for controlling access to hospital information according to an embodiment of the present invention.

FIG. 4 illustrates an example of activity hierarchy in which an activity could be divided into other sub-activities in the system for controlling access to hospital information according to an embodiment of the present invention.

FIG. 5 illustrates the activity hierarchical structure of the system for controlling access to hospital information according to an embodiment of the present invention.

FIG. 6 is a flowchart which shows method for controlling access to hospital information according to an embodiment of the present invention.

### DETAILED DESCRIPTION OF THE PREFERRED EMBODIMENT

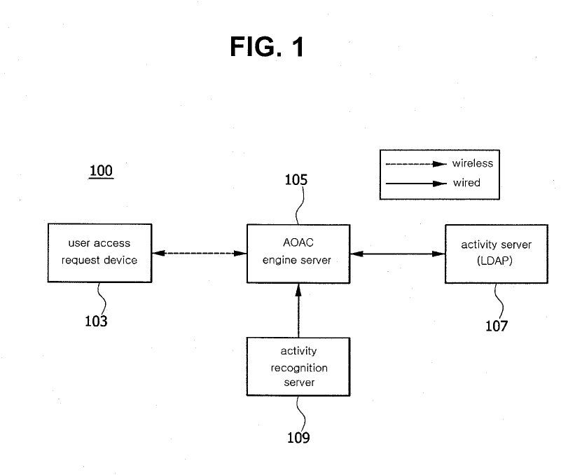

As shown by FIG. 1, the system 100 for controlling access to hospital information according to an embodiment of the present invention comprises a user access request device 103, an activity-oriented access control (AOAC) engine server 105, an activity recognition server 109 and an activity server 107.

A user authenticates himself to the access request device 103 (for example, PDA) by using any mean of authentication such as username/password, smartcard, etc. Then user access request device 103 sends a set of user credentials attaching user attributes such as doctor, employment certificate, etc to the AOAC engine server 105.

The AOAC engine server 105 establishes SSL (Secure Socket Layer) connection with the activity server 107, queries user activity rules from the activity server 107 corresponding to user's attributes. The activity server 107 transmits user activity rules corresponding to user's attributes to the AOAC engine server 105. Further, the AOAC engine server 105 receives user's current work situation from the activity recognition server 109, and transmits an appropriate access request list to the user access request device 103 based on the received current work situation of the user and activity rules corresponding to the user's attributes. The user access request device 103 displays the list so that the list of items which can be accessed by the user is provided to the user. The activity recognition server 109 transmits the current work situation of the user encapsulated in a format of <userID>, <activityID> everytime it recognizes a new work situation of the user.

User requests access to the AOAC engine server 105 by clicking desire request of the displayed access request list, then the AOAC engine server 105 returns results according to the user request (resources or action response) to the user access request device 103.

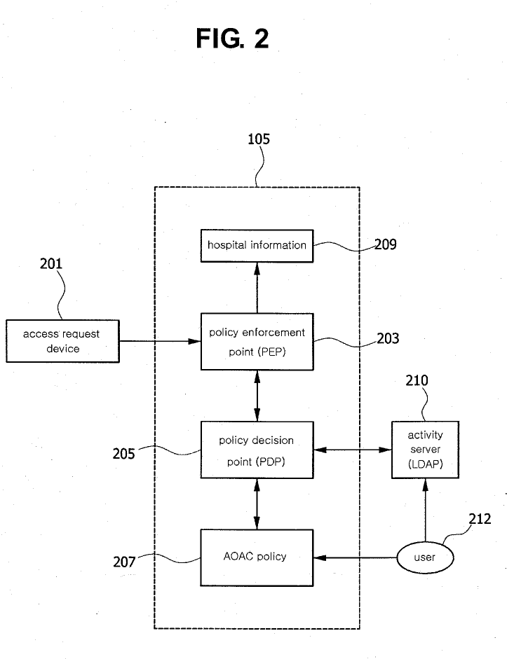

Also, as shown by FIG. 2, the AOAC engine server 105 comprises hospital information 209, a policy enforcement point (PEP) 203, a policy decision point (PDP) 205 and an AOAC policy 207.

The hospital information 209 comprises medical related information as well as non-medical related information such as a medication list, a lab-result, recent visit information, appointment information, immunization information, allergy information, a problem list, insurance information, account information, referrals information, administrative information, staff information, financial information and insurance information, etc.

Also, PEP 203 performs access control by making decision requests and enforcing authorization decisions, and PDP 205 evaluates applicable policies, renders and authorization decisions. At this time, PDP 205 refers to attribute-activity assignment (AAA) rules of the activity server 210 and activity-permission assignment (APA) rules of the AOAC policy 207.

PEP 203 receives an access request from user access request device 201, sends it to PDP 205. The access request sent from PEP 203 to PDP 205 is preferably written in extensible Access Control Markup Language (XACML).

Having received the access request from PEP 203, PDP 205 queries attributes-activity assignment (AAA) rules from the activity server 210. The AAA rules are returned to PDP 205 specifying work activities the user is allowed to perform. Also, PDP 205 queries activity-permission assignment (APA) rules from AOAC policy 207. APA rules are returned to PDP 205 specifying which privileges are granted corresponding to the user's current work situations. PDP 205 returns the response to PEP 203 specifying accept/deny for access request, upon which the user is allowed/denied to make an access to hospital information 209 by using the access request device 201.

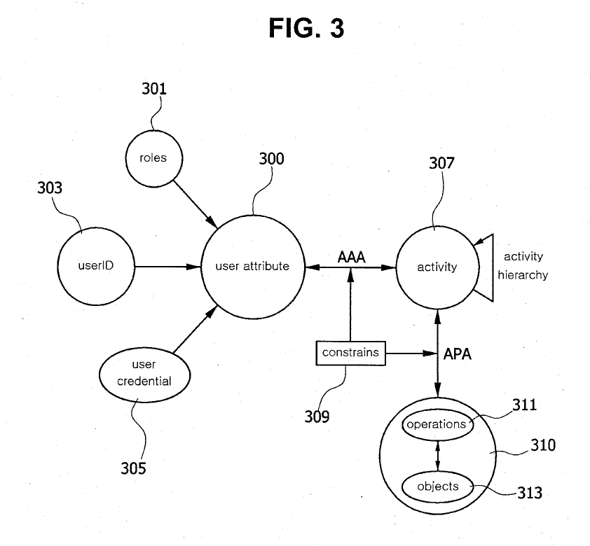

As shown by FIG. 3, each user has a set of attributes 300 including roles 301, userID 303 for identification and other attributes such as job assignment attached in credentials 305. After users are allowed to perform activities 307 based on attribute-activity assignment (AAA) rules, they can perform permissions 310, which are operations (e.g. read, write, execute, etc) 311 on objects 313, by assigning the activities 307 based on activity-permission assignment (APA) rules.

For example, ‘nurse’ Alice with an ‘prescription assignment’ from Doctor John is allowed to perform ‘prescribing medicine for patient James’ action; thus she can ‘read patient records of James’, ‘read X-ray examination’, ‘read blood test result’, and ‘read medicine chart’ as those permissions are granted to the action. Here, ‘nurse’ and ‘prescription assignment’ are user's attributes wherein ‘nurse’ is a role and ‘prescription assignment’ is an attribute attached in an Alice's credential.

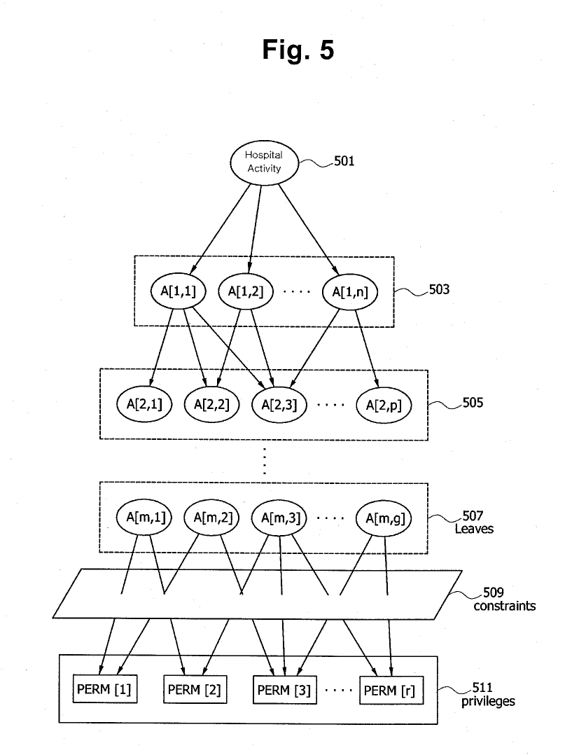

Here, user activities are structured in hierarchy in which an activity can be classified into smaller ones. As shown by FIG. 5, a hospital activity 501 that comprises all activities in hospital is divided into n sub-activities A[1.i](i=1,2, . . . ,n) and then each activity A[1.i] itself is divided into lower-level sub-activities A[2.j] (jε[1.p]). These partitions are continuous until the sub-activities need not to be divided. Here, such sub-activities are called ‘leaves’. The leaves carry a number of privileges PERM[k] (jε[1.r]) if constraints are satisfied. In other words, a user may be authorized to perform a plurality of work activities and each activity is mapped to a plurality of access rights.

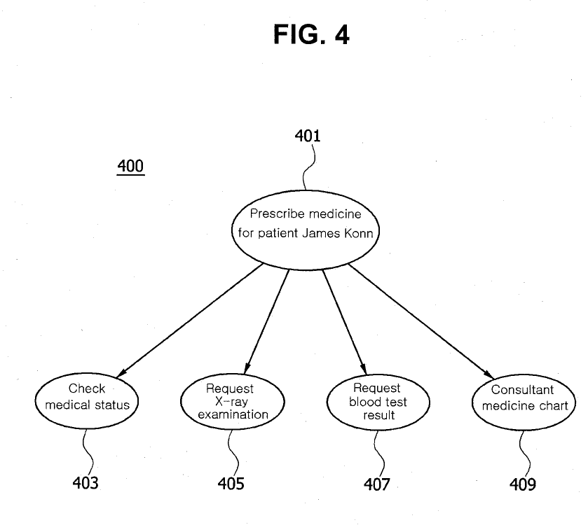

For example, as shown by FIG. 4, an activity ‘prescribe medicine for patient James Konn’ 401 is divided into activities such as ‘check medical status’ 403, ‘request X-ray examination’ 405, ‘request blood test result’ 407 and ‘consult medicine chart’ 409. At this time, an activity ‘prescribe medicine for patient James Konn’ 401 is an activity of upper hierarchy than the other activities.

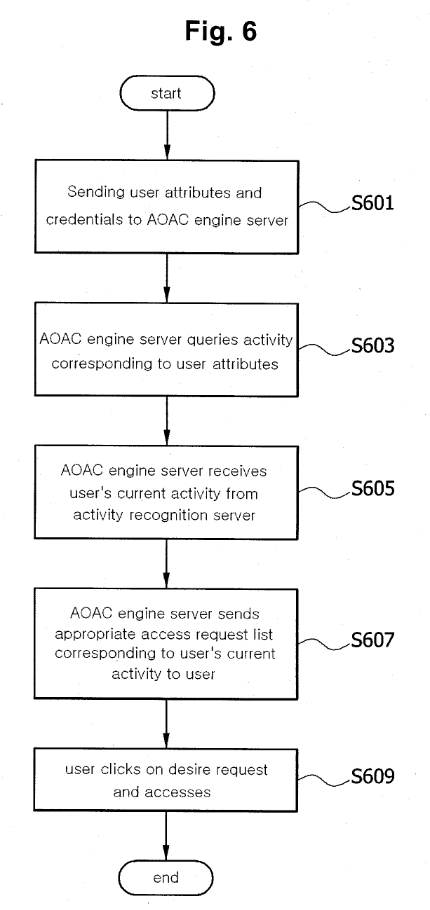

FIG. 6 is a flowchart that shows method for controlling access to hospital information according to an embodiment of the present invention.

First, in step S601, the user sends a set of user credentials attaching user attributes to the activity-oriented access control (AOAC) engine server. Next, in step S603, the AOAC engine server that received the user attributes and credentials queries activity rules allocated to the user attributes from the activity server in which attribute-activity assignment rules are saved, and then receives activity rules corresponding to the user attributes.

Also, in step S605, the AOAC engine server receives user's current work situation from the activity recognition server that senses user's current work situation, then in step S607, sends a permissible access request list to the user based on activity rules corresponding to the received user's current work situation and the user attributes to be displayed in the access request device. Then in step S609, the user sends a request to the AOAC engine server by clicking an item in the list he wants to access and the AOAC engine server returns decision response for the request to the user and then the user can access to hospital information.

The access request device may be a portable small terminal like a PDA, and the user may log in to his access request device by any means of authentication. The means of authentication can use username/password, smartcard, biometric authentication, etc. Further, the user attributes may comprise user's roles and userID. The AOAC engine server may further comprise an authentication server to verify genuineness of the received user credentials.

The activity server may be Lightweight Directory Access Protocol (LDAP), and may further comprise an activity hierarchy in which all work activities in the hospital are constituted. Further, the activity recognition server preferably sends user's new work situation to the AOAC engine server by encapsulating it in a format of <userID> and <activityID> whenever it recognizes the user's new work situation.

Further, an access request from the access request device to the AOAC engine server and a decision response from the AOAC engine server to the access request device are preferably written in extensible Markup Language (XML) format conforming to extensible Access Control Markup Language (XACML) standard.

Accordingly, access rights for hospital information are provided automatically according to user's attributes and current activity.

1-16. (canceled)

17. A system for controlling access to hospital information comprising:
an access request device that sends user credentials, attaching user attributes, to allow a user to access hospital information;
an activity server that stores attribute-activity assignment rules according to said user attributes;
an activity recognition server that senses a current work situation of a user in real-time; and
an activity-oriented access control engine server that receives the user attributes and credentials sent from said access request device, and searches activity rules that are assigned to the user attributes from said activity server, and then searches the current work situation of the user from said activity recognition server, and transmits an access request list corresponding to the activity rules and the current work situation of the user to said access request device.

18. The system according to claim 17, wherein said access request device is a portable small size terminal, the user can log in to said access request device by means of authentication and said means of authentication uses one of a username/password, smartcard, and biometric authentication for authentication.

19. The system according to claim 17, wherein said user attributes include a role of the user and an identification of the user.

20. The system according to claim 17, wherein said activity-oriented access control engine server comprises:
an authentication server that verifies genuineness of the user credentials and user attributes received from the user;
an activity-oriented access control policy that stores activity-permission assignment rules corresponding to detected activities;
a policy decision point that refers to attribute-activity assignment rules from said activity server, and decides at least applicable policy and access authorization by referring to activity-permission assignment rules from said activity-oriented access control policy; and
a policy enforcement point that requests a policy decision to said policy decision point, and performs access according to the decided policy.

21. The system according to claim 17, wherein said activity server is the lightweight directory access protocol, and further comprises an activity hierarchy.

22. The system according to claim 21, wherein all work activities in hospital are constituted in said activity hierarchy.

23. The system according to claim 17, wherein said activity-oriented access control engine server receives a current work situation of the user in a format <userID>, <activityID> from the activity recognition server.

24. The system according to claim 17, wherein an access request from said access request device to said activity-oriented access control engine server and a decision response from said activity-oriented access control engine server to said access request device are written in XML format conforming to extensible Access Control Markup Language standard.

25. A method for controlling access to hospital information, comprising the steps of:
sending user credentials with attached user attributes from a user's access request device to an activity-oriented access control engine server;
receiving, by said activity-oriented access control engine server, activity rules corresponding to the user attributes from an activity server where attribute-activity assignment rules are stored;
receiving, by said activity-oriented access control engine server, a user's current work situation from an activity recognition server;
sending, by said activity-oriented access control engine server, an appropriate access request list to the access request device for displaying in the access request device based on the activity rules allocated to the user attributes and user's current work situation; and
sending, from said access request device, a desired access request in the list upon clicking to the activity-oriented access control engine server, and the activity-oriented access control engine server returning a decision response for the request allowing the user to access hospital information.

26. The method according to claim 25, wherein said access request device is a portable, small-size terminal to which the user can log in by means of authentication which includes one of a username/password, a smartcard, and biometric authentication.

27. The method according to claim 25, wherein said user attributes include a role and an identification of the user.

28. The method according to claim 25, the step of receiving, by said activity-oriented access control engine, server activity rules further comprising:
verifying genuineness of the user credentials received from the user access request device.

29. The method according to claim 25, wherein said activity server is the lightweight directory access protocol and includes an activity hierarchy.

30. The method according to claim 29, wherein all work activities in hospital are constituted in said activity hierarchy.

31. The method according to claim 25, wherein said activity-oriented access control engine server receives a current work situation of the user in a format <userID>, <activityID> from the activity recognition server.

32. The system according to claim 25, wherein the access request from said access request device to said activity-oriented access control engine server and the decision response from said activity-oriented access control engine server to said access request device are written in XML format conforming to extensible Access Control Markup Language standard.
